(19) United States
(12) Patent Application Publication
(10) Pub. No.: US 2006/0098991 A1
(43) Pub. Date: May 11, 2006

(54) Optical communications apparatus

(75) Inventor: Matthew Gibson, Old Amersham (GB)

Correspondence Address: LAHIVE & COCKFIELD, 28 STATE STREET, BOSTON, MA, 02109, US

(73) Assignee: Bookham Technology, PLC, Towcester (GB)

(21) Appl. No.: 10/533,021

(22) PCT Filed: Nov. 3, 2003
(86) PCT No.: PCT/GB03/04747

§ 371 Date: May 2, 2005

(30) Foreign Application Priority Data
Nov. 2, 2002 (GB) 0225600.6

(51) Int. Cl. H04B 10/04

(52) U.S. Cl. 398/197

(57) ABSTRACT

An Optical communications apparatus, comprising: (a) an optical integrated device comprising an input, one or more integrated optical component(s) and an output, arranged such that light received by the input is propagated by the optical component(s) and exits the device as an output light beam; (b) a light beam diverter arranged to divert a sample portion only of the power of the output light beam; (c) a light detector arranged to detect the sample portion of the output light beam; and (d) a polariser located between the light beam diverter and the light detector and/or between the output of the optical integrated device and the light beam diverter, the polariser being arranged such that if light of a predetermined polarisation is received by the optical integrated device, the polariser propagates light of that polarisation only, thereby substantially to prevent light other than of the predetermined polarisation being detected by the light detector.

The present invention relates to an optical communications apparatus, and in particular relates to an optical communications transmitter having an in-built optical power monitor.

It is generally necessary to monitor the optical power output of an optical communications transmitter, in order to monitor (and preferably also to control) the performance of the transmitter. In order to achieve such power monitoring, a sample portion of the output light beam may be diverted to a photodiode or other light detector. However, a problem associated with such power monitoring systems is that if the power monitor forms an integral part of the transmitter and is co-packaged therewith, the amount of stray light received by the light detector is frequently so great that it can swamp the intensity of the light signal which is intended to be detected, for example so that the relative amplitude of the signal is too low to be determined accurately, particularly at low signal power levels. Consequently an accurate determination of the transmitted signal power is frequently impossible.

A known solution to this problem is the use of an optical power monitor that is external to the optical transmitter. However, this solution has the drawback that it increases the number of separate pieces of equipment associated with the transmitter and this clearly increases manufacturing, installation and maintenance costs and complexity.

It would therefore be desirable to have an optical signal transmitter with an integral co-packaged optical power monitor. The present invention seeks (among other things) to enable this. At least in its broadest aspects, however, the invention is not necessarily limited to transmitters having integral co-packaged power monitors, but is applicable generally to an optical communications apparatus that includes a light detector which detects a sample portion of an output light beam.

According to a first aspect, the present invention provides an optical communications apparatus, comprising:

(a) an optical integrated device comprising an input, one or more integrated optical component(s) and an output, arranged such that light received by the input is propagated by the optical component(s) and exits the device as an output light beam;

(b) a light beam diverter arranged to divert a sample portion only of the power of the output light beam;

(c) a light detector arranged to detect the sample portion of the output light beam; and

(d) a polariser located between the light beam diverter and the light detector and/or between the output of the optical integrated device and the light beam diverter, the polariser being arranged such that if light of a predetermined polarisation is received by the optical integrated device, the polariser propagates light substantially of that polarisation only, thereby substantially to prevent light other than that of the predetermined polarisation being detected by the light detector.

The invention has the advantage that by the use of a polariser which substantially prevents light other than that of the predetermined polarisation being detected by the light detector, at least a significant proportion of any light which as been reflected or otherwise scattered during its passage through the optical integrated device (and/or through any intervening optical components between the integrated device and the light detector) may be substantially prevented from being detected by the light detector. This is because reflected or otherwise scattered light undergoes a polarisation change when so reflected or otherwise scattered. Consequently the light detected by the light detector comprises substantially only that of the predetermined polarisation (i.e. the light intended to be detected). Reflected or otherwise scattered light which would normally be detected and hence would normally cause the light detector to provide a false light intensity measurement is substantially blocked by the polariser from detection by the light detector.

The inventor of the present invention has found that, contrary to expectations, if plane polarised light (also known as linearly polarised light) is received by the integrated optical device, a very significant proportion of the light which is reflected or otherwise scattered during its passage through the device undergoes a 90 degrees (i.e. ^{TT}/₂ radians) phase change. For example, the inventor has found that if horizontally plane polarised light (also known as TE polarised light) is received by the integrated optical device, a very significant proportion (and a much greater proportion than expected) of the light that is reflected or otherwise scattered during its passage through the device is output from the device as vertically plane polarised light (also known as TM polarised light). This is contrary to expectations, because it had been expected that reflections and other scattering of the light in the integrated device would result in the random polarisation of the scattered light, which would be much more difficult to eliminate (in the whole of its non-linear entirety) from detection by the light detector than plane polarised light.

This greater than expected proportion of plane polarised light rotated through 90 degrees by scattering may be quantified as follows. If the light which undergoes scattering as it propagates through the integrated device were to experience random changes in its polarisation (as expected prior to the making of the invention) the polariser would block the passage of approximately half of the intensity of the scattered light, thereby reducing the intensity of the scattered “background” light detected by the detector by approximately 3 dB. However, the inventor has found that a reduction in the “background” light detected by the light detector may be reduced by about 10 dB (i.e. a factor of ten, or five times better than expected) by the use of the polariser in accordance with the present invention.

Particularly preferred embodiments of the invention include a light source that generates the light of the predetermined polarisation.

Accordingly, a second aspect of the invention provides an optical communications apparatus, comprising:
(a) a light source arranged to generated light of a predetermined polarisation;
(b) an optical integrated device comprising an input, one or more integrated optical component(s) and an output, arranged such that the light generated by the light source is received by the input, is propagated by the optical component(s) and exits the device as an output light beam;
(c) a light beam diverter arranged to divert a sample portion only of the power of the output light beam;
(d) a light detector arranged to detect the sample portion of the output light beam; and
(e) a polariser located between the light beam diverter and the light detector and/or between the output of the optical integrated device and the light beam diverter, the polariser being arranged to propagate light of the predetermined polarisation only, thereby substantially to prevent light other than that of the predetermined polarisation being detected by the light detector.

In either aspect of the invention, it is preferred for the polariser to be located between the light beam diverter and the light detector. This is because generally the closer to the light detector the polariser is positioned, the more “unwanted” light will be blocked by the polariser from being detected by the light detector.

Preferably the optical communications apparatus according to the invention comprises an optical transmitter.

The light source preferably generates light of the predetermined polarisation only. The light source preferably comprises a laser, especially a diode laser. The laser may be a tunable laser or a fixed wavelength laser. The laser (or other light source) may comprise an integrated optical component of the optical integrated device. It is presently preferred, however, for the light source to be separate from the integrated device.

The optical integrated device preferably comprises a semiconductor device. In the broadest aspects of the invention the semiconductor may comprise any semiconductor material. Preferably, however, the semiconductor is a group III/group V semiconductor, for example GaAs or InP. Alternatively, however, the semiconductor may comprise silicon, for example.

At least one integrated optical component of the integrated device preferably comprises a modulator. Preferably the modulator applies a modulation (most preferably an intensity modulation, but other forms of modulation are possible) to the light received by the device, thereby creating a (modulated) optical signal. The modulator may comprise a Mach-Zehnder modulator or a directional coupler, for example. The modulator preferably is formed from integrated waveguides and one or more integrated variable optical attenuators (for example comprising one or more pin diodes). The input and/or the output of the device preferably comprise(s) an integrated waveguide. Any integrated waveguides of the device preferably comprise rib waveguides, but other types of waveguides may be used.

The light beam diverter preferably comprises a beam splitter, preferably which reflects a portion of the output light beam and transmits the remainder thereof. Preferably the sample portion of the output light beam is reflected by the beam splitter. The sample portion preferably comprises no more than 10%, more preferably no more than 7%, even more preferably no more than 5%, for example approximately 4% of the optical power of the output light beam.

It is generally preferred for the light detector to comprise a photodiode. The light detector preferably is used to measure the optical power of the light incident thereon, thereby to monitor the optical power output of the apparatus. The apparatus therefore preferably comprises an optical signal transmitter with a built-in optical power output monitor, of which the light detector forms a part. The optical power output monitor preferably includes electronics and/or other processing means to process optical power intensity information generated by the light detector.

In at least some embodiments of the invention, the apparatus may include control means arranged to control the light output of the apparatus in response to the light detected by the light detector. In this way, for example, the optical power output of the apparatus may be monitored and controlled internally (although external electronics may be required to provide signal processing). The control means may control the light source itself, but preferably the control means controls at least one variable optical attenuator which preferably is included in the apparatus. The (or each) variable optical attenuator preferably is integrated on the optical integrated device.

As mentioned earlier, the light received by the input of the optical integrated device preferably is plane polarised light (i.e. linearly polarised light). For those embodiments of the invention that include a light source, the light source generates the light of the predetermined polarisation. This may be achieved inherently by the light source, for example by the light source comprising a laser that generates light substantially only of a predetermined polarisation. Alternatively, the light source may include (either integrally formed therewith, or as a separate part) a polariser that determines the polarisation of the light. Most preferably, the light source comprises a laser that generates horizontally plane polarised light (i.e. TE polarised light).

The polariser consequently preferably comprises a plane polariser. Most preferably the polariser is arranged to transmit substantially only horizontally plane polarised (i.e. TE polarised) light.

The polariser preferably comprises glass, preferably including elongate polarising elements therein. The elongate polarising elements preferably comprise metal, for example silver, and preferably comprise elongate crystals. An example of a suitable polariser is sold by Corning Incorporated of New York, USA, under the trade mark Polarcor.

The apparatus according to the invention preferably includes packaging (for example a housing) in which the optical integrated device, the light beam diverter, the light detector, the polariser, and (where present) the light source are contained. Consequently, for those embodiments of the invention in which the light detector comprises part of an optical power monitor, the optical power monitor preferably is co-packaged with the optical integrated device and the light source (for those embodiments of the invention which include a light source.)

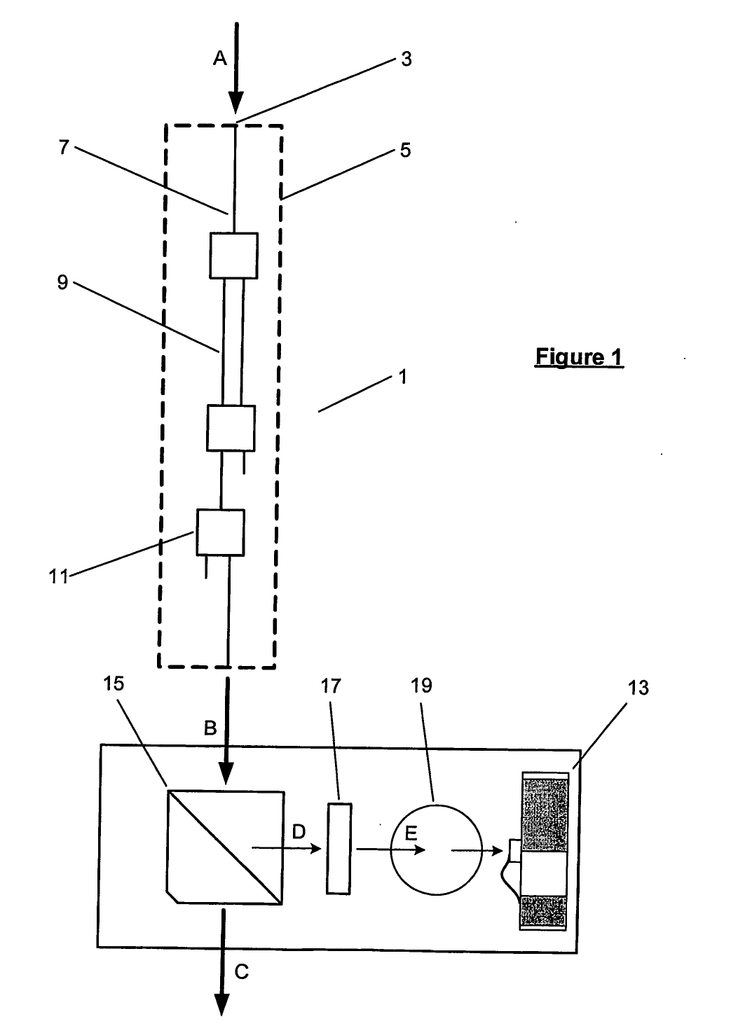

An embodiment of the invention will now be described, by way of example, with reference to the accompanying FIG. 1, which is a schematic illustration of the main components of an optical communications apparatus according to the invention, and their mutual arrangement.

FIG. 1 shows, schematically, an optical communications apparatus 1 according to the invention, in the form of an optical signal transmitter. Light (represented by arrow A) from a laser light source (not shown) is received by an input 3 of an optical integrated device 5. The device 5 comprises a semiconductor optical chip, preferably formed from a group III/group V semiconductor, e.g. GaAs. An input waveguide 7 guides the light to a Mach-Zehnder modulator 9 comprising two parallel waveguides. The modulator 9 is controlled by control electronics (not shown) such that it applies a modulation to the light, thereby generating an optical signal to be transmitted by the apparatus. A variable optical attenuator 11 controls the power of the light that is output by the device 5 as an output light beam (represented by arrow B). The variable optical attenuator 11 is controlled, by means of further control electronics (also not shown) responsive to optical power detected by a photodiode light detector 13, as explained below.

The output light beam B from the integrated device 5 is directed to a light beam diverter 15 in the form of a beam splitter. The majority of the optical power of the output light beam B (for example 96%) is transmitted directly through the beam splitter 15 and is launched into an optical network (via coupling lenses and an optical fibre, not shown) as the output C of the optical signal transmitter 1. The remainder of the output beam B is reflected by the beam splitter 15 through 90 degrees as the sample portion D (i.e. in this case 4% of the power) of the output beam. The sample portion D is directed by the beam splitter towards a polariser 17.

The light A generated by the laser light source (not shown) and received by the input 3 of the integrated device 5 is plane polarised with a predetermined polarisation, for example horizontally plane polarised (i.e. it has TE polarisation). However, during its propagation through the device 5 some of the light will have been reflected or otherwise scattered in such a way that its plane of polarisation will have been rotated through 90 degrees (or ^{TT}/₂ radians) so that it is vertically polarised, i.e. it has TM polarisation.

The scattering of the light in the device 5 may also have resulted in some of the light having other polarisations, but as discussed earlier, this proportion is unexpectedly small. Nonetheless, the presence of other polarisations may result in some light not having the predetermined polarisation being detected by the light detector 13. This background optical noise level detected by the light detector can be accounted for and counteracted by the use of a constant electrical signal of equivalent amplitude used as a fixed offset or otherwise, for example.

Consequently, the sample portion D of the output light beam B will be a mixture of polarisations. The plane polariser 17, which preferably comprises a glass plate containing elongate crystals of silver, is orientated such that it propagates light of substantially only the predetermined polarisation, i.e. horizontally, or TE, polarised light. The vertically, or TM, polarised component of the light is substantially blocked by the polariser 17. The horizontally polarised portion E of the sample portion D of the output beam B then passes through a ball lens 19 and is focussed onto the photodiode light detector 13. Consequently, the vertically (TM) polarised light, which constitutes optical noise, is substantially prevented from being detected by the photodiode 13, and therefore the photodiode detects a significantly more accurate, representative, sample portion of the optical signal transmitted by the transmitter than would be the case in the absence of the polariser 17. This is because only the horizontal (TE) polarised light carrying the optical signal created by the modulator 9 constitutes the optical signal to be transmitted over the optical network and received by remote receivers. The light of other polarisations within the apparatus constitutes noise.

The optical power of the horizontally polarised sample portion E detected by the photodiode 13 is used by control electronics (not shown) to control the output power of the laser and/or to control the variable optical attenuator 11 (the latter being preferred), and thereby to control the output power of the apparatus I (i.e. the optical signal transmitter).

Additionally or alternatively to placing the polariser between the light beam diverter and the light detector, a plane polariser (not shown) arranged to propagate light of substantially only the predetermined polarisation (i.e. in this case the horizontally, or TE, polarised light) may be placed between the output of the device 5 and the beam splitter 15 (i.e. in beam B) and/or in the path of the light beam C which is transmitted unreflected through the beam diverter 15. This has the advantage of substantially preventing light other than that of the predetermined polarisation being transmitted by the apparatus, and consequently significantly reduces the amount of optical noise introduced into the network by the optical signal transmitter.

1. An optical communications apparatus, comprising:
(a) an optical integrated device comprising an input, one or more integrated optical components and an output, arranged such that light received by the input is propagated by the one or more optical components and exits the device as an output light beam;
(b) a light beam diverter arranged to divert a sample portion only of the power of the output light beam;
(c) a light detector arranged to detect the sample portion of the output light beam; and
(d) a polariser located between the light beam diverter and the light detector and/or between the output of the optical integrated device and the light beam diverter, the polariser being arranged such that if light of a predetermined polarisation is received by the optical integrated device, the polariser propagates light of that polarisation only, thereby substantially to prevent light other than that of the predetermined polarisation being detected by the light detector.

2. An apparatus according to claim 1, further comprising a light source that generates light of the predetermined polarisation.

3. An optical communications apparatus, comprising:
(a) a light source arranged to generate light of a predetermined polarisation;
(b) an optical integrated device comprising an input, one or more integrated optical components and an output, arranged such that the light generated by the light source is received by the input, is propagated by the one or more optical components and exits the device as an output light beam;
(c) a light beam diverter arranged to deliver a sample portion only of the power of the output light beam;
(d) a light detector arranged to detect the sample portion of the output light beam; and
(e) a polariser located between the light beam diverter and the light detector and/or between the output of the optical integrated device and the light beam diverter, the polariser being arranged to propagate the light of the predetermined polarisation only, thereby substantially to prevent light other than that of the predetermined polarisation being detected by the light detector.

4. An apparatus according to claim 3, wherein the light source comprises a laser.

5. An apparatus according to claim 3, wherein the light source comprises an integrated optical component of the optical integrated device.

6. An apparatus according to any claim 3, further comprising an optical signal transmitter.

7. An apparatus according to claim 3, wherein the optical integrated device comprises a semiconductor device.

8. An apparatus according to claim 3, wherein said integrated optical component comprises a modulator.

9. An apparatus according to claim 8, wherein the modulator applies a modulation to the light received by the input of the optical integrated device.

10. An apparatus according to claim 3, wherein the light beam diverter comprises a beam splitter.

11. An apparatus according to claim 3, wherein the sample portion of the output light beam comprises no more than 10% of the power of the output light beam.

12. An apparatus according to claim 3, wherein the light detector comprises a photodiode.

13. An apparatus according to claim 3, wherein the light detector comprises at least part of an optical power monitor that monitors the optical power output of the apparatus.

14. An apparatus according to claim 3, including further comprising control means arranged to control a light output of the apparatus in response to the light detected by the light detector.

15. An apparatus according to claim 14, further comprising control means arranged to control a light output of the apparatus in response to the light detected by the light detector, wherein optical power monitor and the control means together monitor and control the optical power output of the apparatus.

16. An apparatus according to claim 3, wherein the predetermined polarisation of the light comprises a predetermined plane polarisation.

17. An apparatus according to claim 16, wherein the predetermined polarisation comprises horizontally plane polarised light.

18. An apparatus according to claim 3, wherein the polariser comprises a plane polariser.

19. An apparatus according to claim 3, further comprising a lens located between the beam diverter and the light detector, to direct substantially all of the sample portion of the light beam, such that it is detected by the light detector.

20. An apparatus according to claim 3, comprising an additional polariser arranged in the path of that part of the output light beam not diverted by the light beam diverter, the polariser being arranged to propagate light of the predetermined polarisation only, thereby substantially to prevent light other than that of the predetermined polarisation being transmitted by the apparatus.

21. An apparatus according to claim 3, further comprising a source of electrical current arranged to apply a generally constant electrical signal to counteract any generally constant background optical noise detected by the light detector.
